(19) United States
(12) Patent Application Publication
(10) Pub. No.: US 2004/0145446 A1
(43) Pub. Date: Jul. 29, 2004

(54) Overload prevention plug structure

(76) Inventor: James Chou, Taipei (TW)

Correspondence Address: TROXELL LAW OFFICE PLLC, 5205 LEESBURG PIKE 1404, FALLS CHURCH, VA, 22041, US

(21) Appl. No.: 10/351,142

(22) Filed: Jan. 27, 2003

(51) Int. Cl. H01H 61/00

(52) U.S. Cl. 337/36; 337/37

(57) ABSTRACT

An overload prevention plug structure has a power line, a plug and an overload shift. The power line has a hot wire and a ground wire. The plug has a hot wire pin and a ground wire pin. The ground wire pin is electrically connected to the ground wire of the power line. The overload shift has a hot wire contacting portion and a pin contacting portion. The hot wire contacting portion is electrically connected to the hot wire of the power line and the pin contacting portion is electrically connected to the hot wire pin of the plug to establish an electric connection. The overload has a dual metal piece that deforms and bends as its temperature increases. Alternatively, the overload is a positive temperature coefficient (PTC) thermstor with a resistance that increases or decreases as its temperature increases or decreases.

### BACKGROUND OF THE INVENTION

1. Field of the Invention

The invention relates to an overload prevention plug structure and, more particularly, to an overload prevention plug structure that achieves an electric disconnection when an electric overload occurs.

2. Description of the Related Art

Domestic electrical power is usually supplied to a terminal electrical appliance via an electrical socket. The electrical socket may be provided with more than one pair of contact jacks through which the plug of the electrical appliance is inserted to supply an electrical power. However, the electric power load must be carefully controlled to prevent accidents caused by electric overload of the power line or the electrical socket. In order to achieve this purpose, the electrical socket is usually provided with a control mechanism for electrical disconnection and connection.

As illustrated in FIG. 1, a conventional plug device includes a power line 5 and a plug body 6. The plug body 6 has a hot wire pin 60 and a ground wire pin 61 that extend from the plug body 6 to connect electrically to a hot wire (not shown) and a ground wire (not shown), respectively, of the power line 5.

In the above plug device known in the art, the power line is externally connected to a multi-jack electric socket or an electric device. The multi-jack electric socket may be subjected to an electric overload when connected to an excessive amount of electric devices, resulting in electric accidents. Furthermore, electric components of the electric device may also be damaged by the electric overload.

### SUMMARY OF THE INVENTION

It is therefore an object of the invention to provide an overload prevention plug structure that protects a power line and an electric socket from being damaged by an excessive electric current.

It is another object of the invention to provide an overload prevention plug-structure that protects an electric device from being damaged by an unstable electric current.

To accomplish the above and other objectives, an overload prevention plug structure of the invention includes a power line, a plug and an overload shift. The power line includes a hot wire and a ground wire. The plug includes a hot wire pin and a ground wire pin. The ground wire pin is electrically connected to the ground wire of the power line. The overload shift includes a hot wire contacting portion and a pin contacting portion. The hot wire contacting portion is electrically connected to the hot wire of the power line and the pin contacting portion is electrically connected to the hot wire pin of the plug to establish an electric connection.

The overload includes a dual metal piece that deforms and bends according to a temperature increase, which increase is caused by an electric current overload. The current flowing through the electric device is thereby maintained in a normal rated power range. Alternatively, the overload shift is a positive temperature coefficient (PTC) thermistor. When the electric current passing through the power line is excessively high, which leads to an increase in temperature, a resistance of the PTC thermistor increases to lower the electric current flow.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective view of a conventional plug;

FIG. 2 is an exploded view of an overload prevention plug structure according to a first preferred embodiment of the invention;

FIG. 3 is a cross-sectional view of an overload prevention plug structure in electric connection according to a first preferred embodiment of the invention;

FIG. 4 is a schematic view showing an operational button of an overload prevention plug structure in electric connection according to a first preferred embodiment of the invention;

FIG. 5 is a cross-sectional view of an overload prevention plug structure in electric disconnection according to a first preferred embodiment of the invention;

FIG. 6 is a schematic view showing an operational button of an overload prevention plug structure in electric disconnection according to a first preferred embodiment of the invention;

FIG. 7 is an exploded view of an overload prevention plug structure provided with a light illuminating device according to a first preferred embodiment of the invention;

FIG. 8 is a perspective view of an overload prevention plug structure according to a second preferred embodiment of the invention;

FIG. 9 is an exploded view of an overload prevention plug structure provided with a light illuminating device according to a second preferred embodiment of the invention;

FIG. 10 is a cross-sectional view of an overload prevention plug structure in electric connection according to a third preferred embodiment of the invention;

FIG. 11 is a cross-sectional view of an overload prevention plug structure in electric connection taken from a direction different from that of FIG. 10;

FIG. 12 is a cross-sectional view of an overload prevention plug structure in electric disconnection according to a third preferred embodiment of the invention; and

FIG. 13 is a cross-sectional view of an overload prevention plug structure in electric disconnection taken from a direction different from that of FIG. 13.

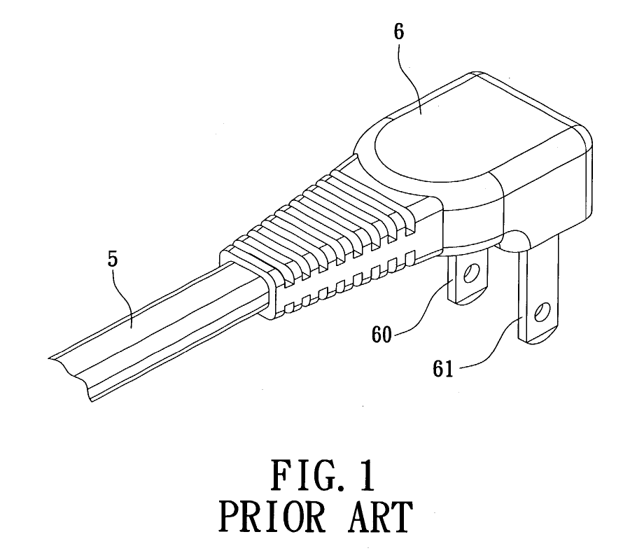

### DETAILED DESCRIPTION OF THE EMBODIMENTS

Wherever possible in the following description, like reference numerals will refer to like elements and parts unless otherwise illustrated.

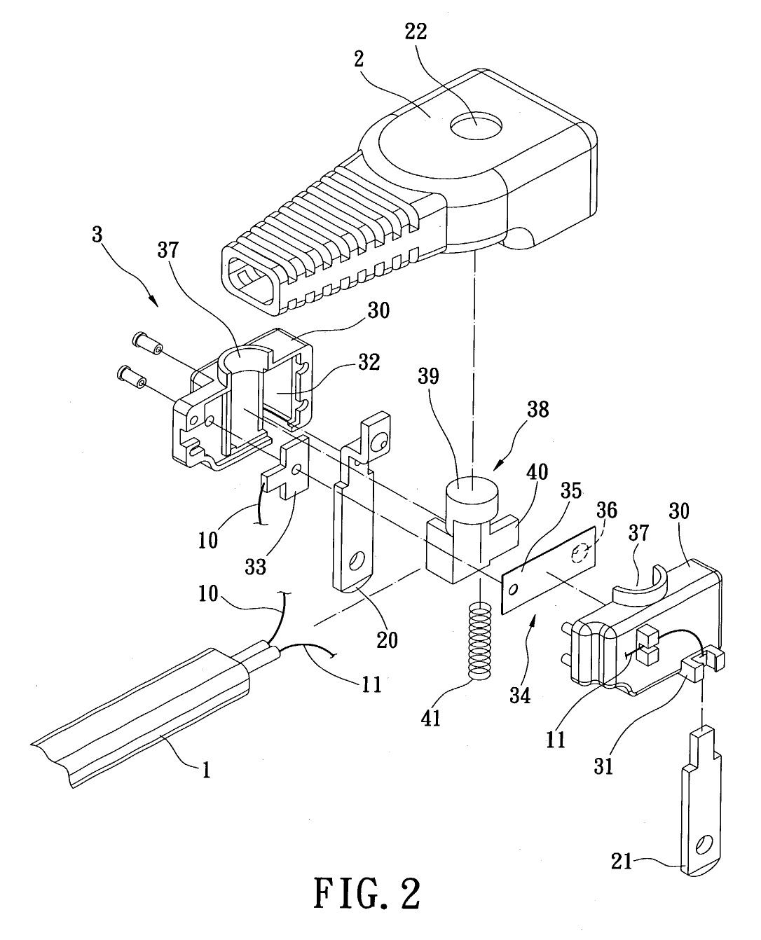

Referring to FIG. 2, the invention provides an overload prevention plug structure that includes a power line 1, a plug 2 and an overload shift 3.

The power line 1 includes a hot wire 10 and a ground wire 11 in parallel with each other.

The plug 2 includes a hot wire pin 20 and a ground wire pin 21 in parallel with each other. The ground wire pin 21 is electrically connected to the ground wire 11. The plug 2 is further formed with a through hole 22.

The overload shift 3 is mounted in the plug 2. The overload shift 3 includes a casing 30. A pin reception 31 is mounted on an external side surface of the casing 30 for receiving the ground wire pin 21. A retaining slot 32 is formed inside the casing 30 for fastening the hot wire pin 20. A hot wire conductor 33 is further mounted inside the casing 30 for electrically connecting the hot wire 10. A dual metal piece 34 is mounted inside the casing 30 and includes a hot wire contacting portion 35 and a pin contacting portion 36. The hot wire contacting portion 35 is fixed and is electrically connected to the hot wire conductor 33. The pin contacting portion 36 is freely electrically connected to the hot wire pin 20. An opening 37 is formed between the retaining slot 32 and the hot wire conductor 33, corresponding to the through hole 22 of the plug 2. An operational button 38 including a pressing portion 39 and a sliding piece 40, is movably mounted in the opening 37. One end of the pressing portion 39 protrudes through the opening 37 and the through hole 22, and the other end thereof is mounted with a resilient member 41 such as a spring. The sliding piece 40 moves between the hot wire pin 20 and the pin contacting portion 36 of the dual metal piece 34. When a normal electric connection is established, the sliding pieces 40 snap fit with the hot wire pin 20 and the dual metal piece 34.

The hot wire pin 20,.the ground wire pin 21, the overload shift 3, the hot wire 10 and the ground wire 11 are assembled together and molded into polyvinyl chloride (PVC).

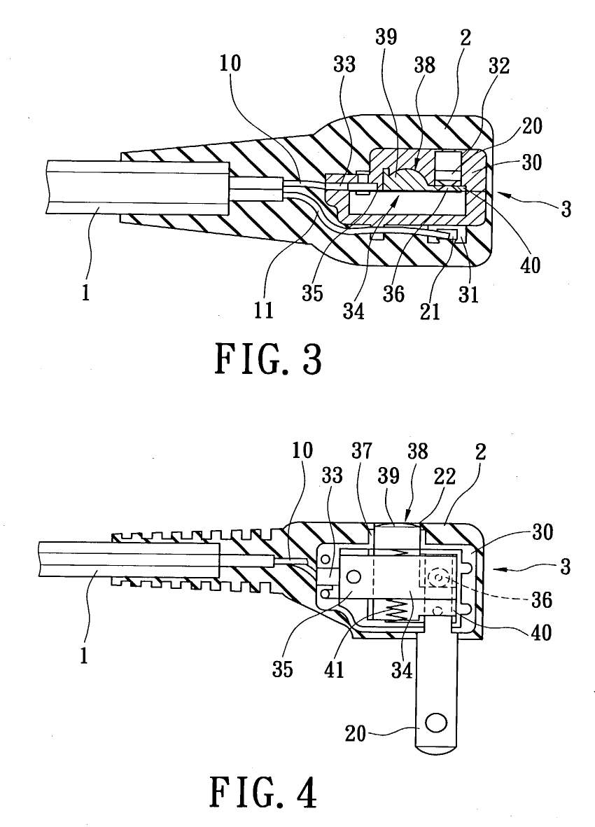

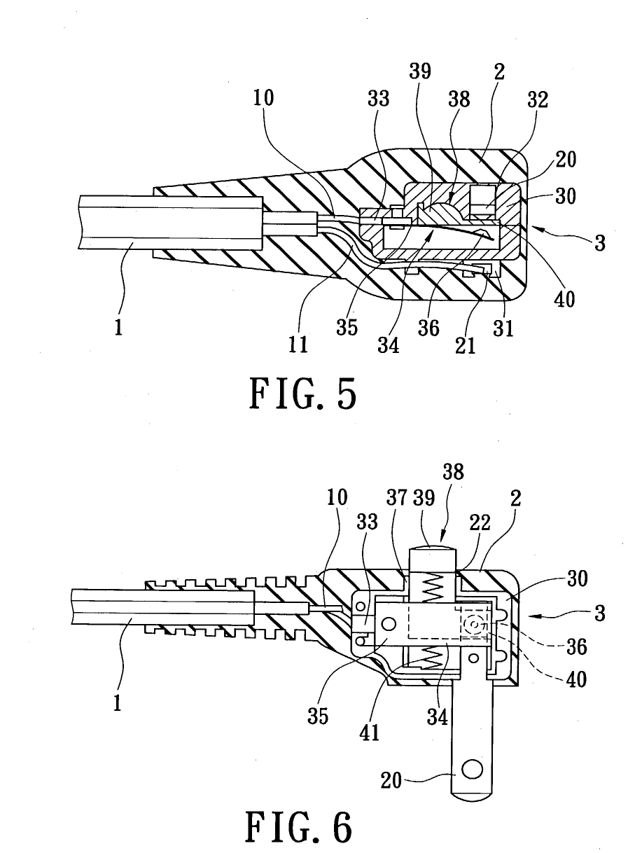

Referring to FIG. 3 through FIG. 6, the power line 1 is externally connected to a multi-jack electric socket (not shown) that is electrically connected to a plurality of electric devices. The hot wire pin 20 and the ground wire pin 21 of the plug 2 are electrically connected to an electric power source. The dual metal piece 34 of the overload shift 3 can bear a normal rated power current such as 1.5 A. When the total current exceeds the normal rated power current, the dual metal piece 34 of the overload shift 3 deforms and bends due to a rise in temperature caused by the power overload. Therefore, the pin contacting portion 36, which is freely connected to the hot wire pin 20, disconnects from the hot wire pin 20 as the dual metal piece 34 deforms and bends. At the same time, the pressing portion 39 is pushed by the resilient member to protrude through the through hole 22 of the plug 2, allowing the sliding piece 40 to separate the pin contacting portions 36 from the hot wire pin 20. Accidental burning caused by an electric power overload can thereby be avoided. When the electric power load is reduced, thus loweringthe temperature inside the electric socket, the pin contacting portion 36 returns to its initial position, and the pressing portion 39 presses the sliding piece 40 downward to reconnect electrically the pin contacting portion 36 to the hot wire pin 20.

The power line 1 can be further externally connected to an additional electric device (not shown). The hot wire pin 20 and the ground wire pin 21 of the plug 2 are electrically connected to an external electric power source. The normal rated power of the dual metal piece 34 of the overload shift 3 is based on the electric device that is to be connected electrically. The normal rated power can be, for example, 3A. When an unstable electric current flows, the electric device is protected by the overload shift 3 of the invention. Therefore, the overload shift of the invention can replace a conventional safe fuse or circuit breaker, which simplifies the configuration of components in the electric device and reduces its production cost.

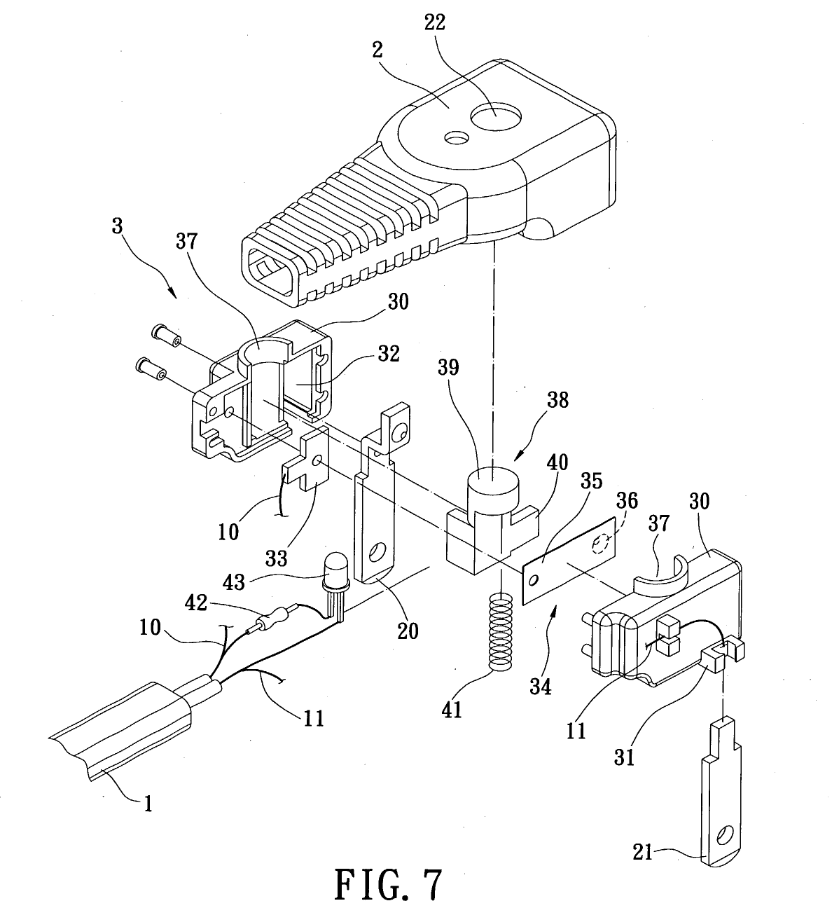

Referring to FIG. 7, a resistor 42 and a light illuminating element 43 such as light-emitting device (LED) are respectively connected in series between the hot wire 11 and the ground wire 10 of the power line 1, and in parallel with the overload shift 3. When the amount of electric current is nearly equal to the normal rated power, the light illuminating element 43 is activated to alert the user that the electric device is about to be overloaded.

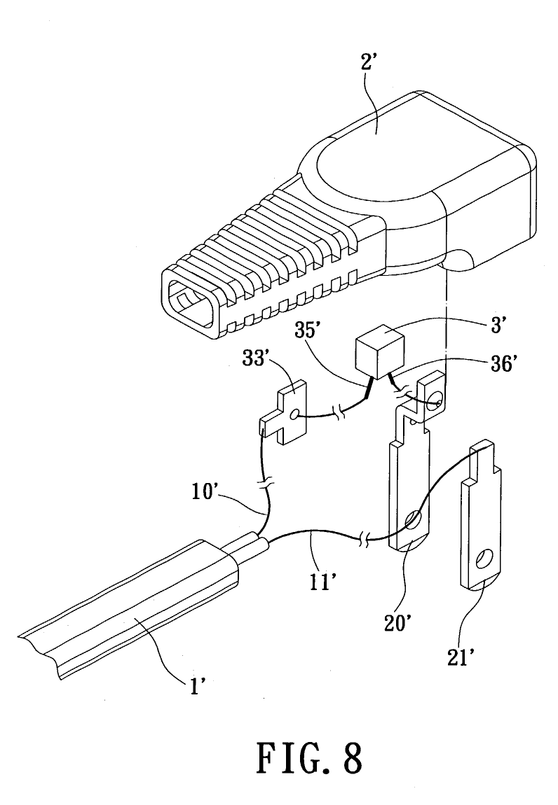

Referring to FIG. 8, an overload shift 3′ is a positive temperature coefficient thermistor (PTC thermistor) that has two metal pins; one is a hot wire contacting portion 35′ and the other is a pin contacting portion 36′. The hot wire contacting portion 35′ is electrically connected to a hot wire conductor 33′ connected to a hot wire 10′ of a power line 1′. The pin contacting portion 36′ is electrically connected to a hot wire pin 20′ of a plug 2′. When an undue electric current passes through the power line 1′, the resistance of the PTC thermistor is increased to reduce the electric current flowing through the electric device. When the electric current is lower than the value required to drive the electric device, there is not enough power to drive the electric device. After the temperature returns to its normal value, the resistance of the PTC thermistor is lowered to re-establish an electrical connection of the electric device.

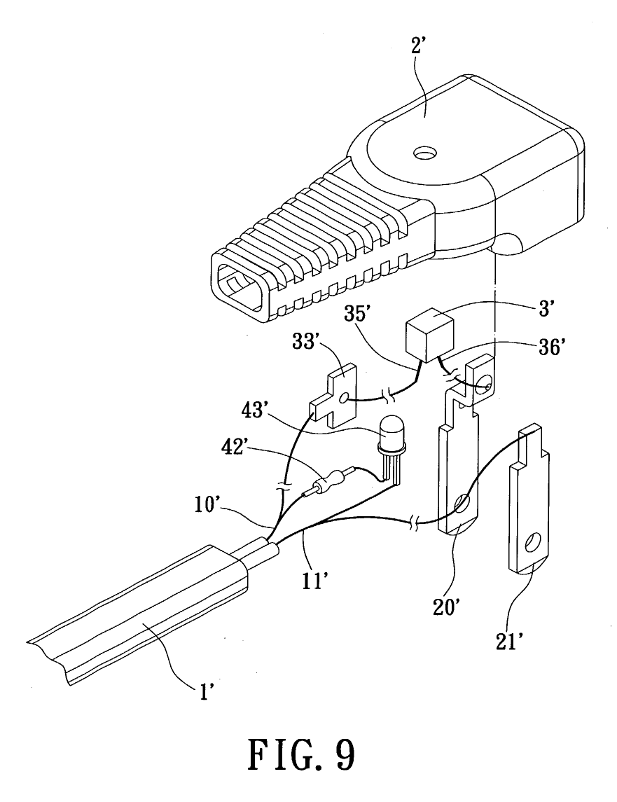

Referring to FIG. 9, a resistor 42′, a light illuminating element 43′ and the overload shift 3′ (being the PTC thermistor in this embodiment) are connected in parallel, so that the user will be alerted of an electric power overload.

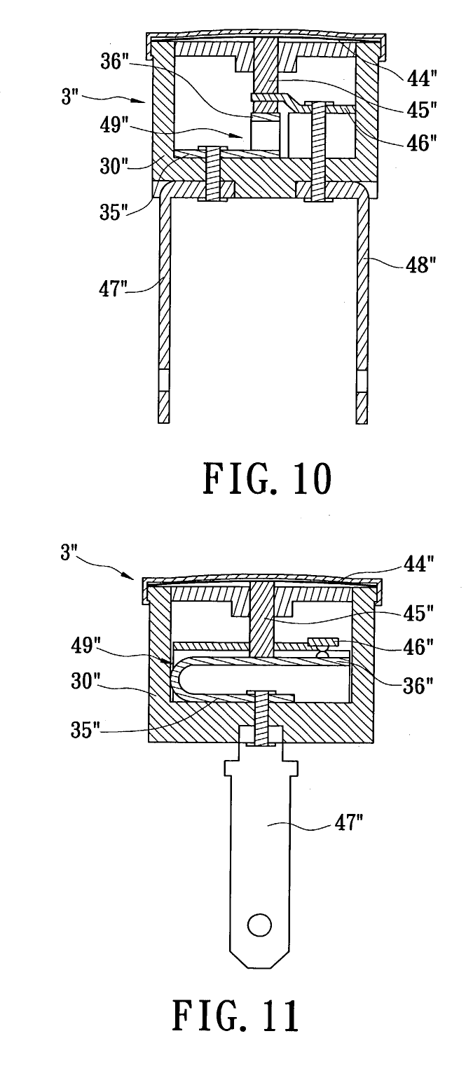

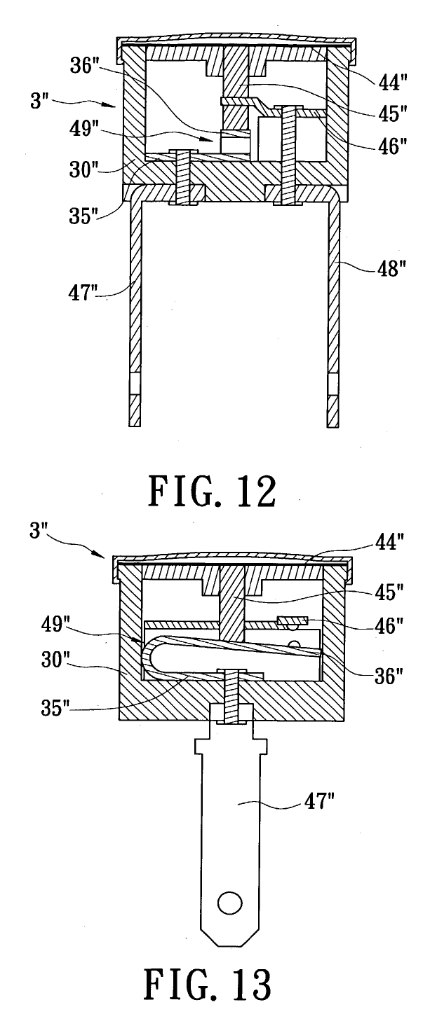

Referring to FIG. 10 through FIG. 13, the overload shift 3″ is a temperature switch, including a casing 20″. A resilient conductive piece 49″, including a hot wire contacting portion 35″ and a pin contacting portion 36″, is mounted inside the casing 30″. The hot wire contacting portion 35″ is stationary while the pin contacting portion 36″ is movable. The hot wire contacting portion 35″ is externally connected to a pin 47″ to connect electrically to the hot wire of the power line (not shown). A stationary conductive piece 46″ is further mounted inside the casing 30″ and externally connected to a pin 48″ to connect electrically to the hot wire pin of the plug (not shown). The pin contacting portion 36″ of the resilient conductive piece 49″ keeps in contact with the stationary conductive pin 46″ to connect electrically the pin contacting portion 36″ to the hot wire pin (not shown). A dual metal piece 44″ is mounted at a side of the pin contacting portion 36″. A stud 45″ is mounted on a surface of the dual metal piece 44″. An end of the stud 45″ opposite the dual metal piece 44″ is pressed against the pin contacting portion 36″. The temperature inside the casing 30″ increases as the electric current increases. The dual metal piece 44″ deforms and bends due to the increased temperature, and therefore pushes the stud 45″ against the pin contacting portion 36″ to separate the pin contacting portion 36″ from the stationary conductive piece 46″. After the temperature inside the casing 30″ is lowered, the dual metal piece 44″ returns to its initial position to contact the pin contacting portion 36″ with the stationary conductive piece 46″ and establish the electric connection again.

As described above, the invention therefore provides the following advantages:

1. The dual metal piece deforms and bends as the temperature increases, which is caused by the electric current load, so that the current flowing through the electric device is maintained in a normal rated power range. Therefore, the power line and the electric socket are not damaged when an overloaded electric power occurs. When the undue electric current passes, the dual metal piece deforms and bends to obtain an electric disconnection. Thereby, the electric components of the electric device are protected.

2. The resistance of the PTC thermistor varies as the temperature generated by the electric current load changes in order to control the current passing through the electric device within a normal rated current range. The power line and the electric socket are not damaged when an electric power overload occurs. When the undue electric current passes, the dual metal piece deforms and bends to obtain an electric disconnection. Thereby, the electric components of the electric device are protected.

3. The light illuminating element alerts the user of an electric power overload to prevent any electric accident.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An overload prevention plug structure comprising:
a power line, comprising a hot wire and a ground wire;
a plug, comprising a hot wire pin and a ground wire pin, wherein the ground wire pin is electrically connected to the ground wire of the power line; and
an overload shift, comprising a hot wire contacting portion and a pin contacting portion, wherein the hot wire contacting portion is electrically connected to the hot wire of the power line and the pin contacting portion is electrically connected to the hot wire pin of the plug to establish an electric connection.

2. The overload prevention plug structure of claim 1, wherein the overload shift includes a casing on an external side surface of which a pin reception is mounted for receiving the ground wire pin.

3. The overload prevention plug structure of claim 1, wherein the overload shift includes a casing in which a retaining slot is formed for fastening the hot wire pin of the plug.

4. The overload prevention plug structure of claim 1, wherein the overload shift includes a casing in which a dual metal piece including a hot wire contacting portion and a pin contacting portion are mounted.

5. The overload prevention plug structure of claim 1, wherein the overload shift includes a casing in which a hot wire conductor is further mounted for electrically connecting the hot wire.

6. The overload prevention plug structure of claim 4, wherein the plug has a through hole, and the casing of the overload shift has an opening corresponding to the through hole of the plug, an operational button being mounted through the opening, the operational button including a pressing portion and a sliding piece, one end of the pressing portion protruding through the opening and the through hole, and another end of the pressing portion being mounted with a resilient member, the sliding piece moving between the hot wire pin and the pin contacting portion of the dual metal piece.

7. The overload prevention plug structure of claim 6, wherein the resilient member is a spring.

8. The overload prevention plug structure of claim 1, wherein the hot wire pin, the ground wire pin, the overload shift, the hot wire and the ground wire are assembled together and molded into polyvinyl chloride (PVC).

9. The overload prevention plug structure of claim 1, wherein the overload shift is a positive temperature coefficient thermistor that has two metal pins, one of the pins being a hot wire contacting portion and the other being a pin contacting portion.

10. The overload prevention plug structure of claim 1, wherein a resistor and a light illuminating element are respectively connected in series between the hot wire and ground wire of the power line, and in parallel with the overload shift.

11. The overload prevention plug structure of claim 1, wherein:
the overload shift includes a casing, wherein a resilient conductive piece including a hot wire contacting portion and a pin contacting portion is mounted, the hot wire contacting portion being stationary and the pin contacting portion being movable, the hot wire contacting portion being externally connected to a first pin to connect electrically to the hot wire of the power line;
a stationary conductive piece is further mounted inside the casing and externally connected to a second pin to connect electrically to the hot wire pin of the plug;
the pin contacting portion of the resilient conductive piece maintains contact with the stationary conductive pin to connect electrically the pin contacting portion to the hot wire pin;
a dual metal piece is mounted at a side of the pin contacting portion;
a stud is mounted on a surface of the dual metal piece, an end of the stud opposite to the dual metal piece being pressed against the pin contacting portion; and
the dual metal piece deforms and bends due to an increased temperature to push the stud against the pin contacting portion whereby the pin contacting portion is separated from the stationary conductive piece.
